(19) United States
(12) Patent Application Publication
(10) Pub. No.: US 2007/0097252 A1
(43) Pub. Date: May 3, 2007

(54) Imaging methods, cameras, projectors, and articles of manufacture

(76) Inventor: D. Amnon Silverstein, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,653

(22) Filed: Oct. 31, 2005

(51) Int. Cl. H04N 9/07

(52) U.S. Cl. 348/336

(57) ABSTRACT

Imaging methods, cameras, projectors, and articles of manufacture are described according to some aspects of the disclosure. According to one aspect, an imaging method includes providing light of a plurality of regions of an input image, associating light of an individual one of the regions of the input image with a plurality of spatially separated regions, wherein the light of one of the regions of the input image comprises a plurality of wavelengths of light and wherein the spatially separated regions which correspond to the one region of the input image individually comprise light of a respective individual wavelength of the light present in the one region of the input image, providing a plurality of electrical signals, wherein respective ones of the electrical signals correspond to respective ones of the spatially separated regions and respective ones of the different wavelengths of light, and wherein the light of one of the spatially separated regions is substantially all of the light of the respective wavelength of the light of the one region of the input image.

### FIELD OF THE DISCLOSURE

Aspects of the disclosure relate to imaging methods, cameras, projectors, and articles of manufacture.

### BACKGROUND OF THE DISCLOSURE

Numerous advancements have been made recently with respect to imaging devices and methods. For example, image sensors in digital cameras have been fabricated which capture images at increased resolutions and projectors have been similarly improved to project images at increased resolutions. The increased ease, quality and flexibility of digital representations of images have led to increased popularity of digital imaging systems.

Other aspects of digital imaging systems have also been improved or enhanced to provide users with suitable alternatives to film based imaging systems. For example, in addition to higher resolutions attainable with recent digital devices, image processing algorithms such as color balancing have also been improved to increase the ability of digital imaging systems to capture and generate images which more closely represent a received image of a scene in camera applications or project images which more closely represent an inputted image for display.

At least some aspects of the disclosure provide improved systems and methods for generating images.

### SUMMARY

According to some aspects of the disclosure, exemplary imaging methods, cameras, projectors, and articles of manufacture are described.

According to one embodiment, an imaging method comprises providing light of a plurality of regions of an input image, associating light of an individual one of the regions of the input image with a plurality of spatially separated regions, wherein the light of one of the regions of the input image comprises a plurality of wavelengths of light and wherein the spatially separated regions which correspond to the one region of the input image individually comprise light of a respective individual wavelength of the light present in the one region of the input image, providing a plurality of electrical signals, wherein respective ones of the electrical signals correspond to respective ones of the spatially separated regions and respective ones of the different wavelengths of light, and wherein the light of one of the spatially separated regions is substantially all of the light of the respective wavelength of the light of the one region of the input image.

According to another embodiment, a camera comprises an optical system configured to receive a plurality of different wavelengths of light of an input image and to generate a plurality of light beams using the light of the input image and comprising respective ones of the wavelengths of light, wherein the generation of the light beams comprises separating the light of the input image into the light beams corresponding to a plurality of spatially separated regions, and an image generation device optically coupled with the optical system and configured to receive the light beams at the spatially separated regions and to generate image data of a representation of the input image using the light of the received light beams, wherein the light beams received by the image generation device comprise substantially an entirety of the light of the respective wavelengths of light of the input image received by the camera.

Other embodiments are described as is apparent from the following discussion.

### DESCRIPTION OF THE DRAWINGS

FIG. 1 is a functional block diagram of an imaging device according to one embodiment.

FIG. 2 is a functional block diagram of an imaging system of an imaging device according to one embodiment.

FIGS. 3A-3B are illustrative representations of imaging systems according to exemplary embodiments.

FIG. 4 is an illustrative representation of an image generated according to at least one embodiment.

FIG. 5 is a flow chart of an exemplary imaging method according to one embodiment.

### DETAILED DESCRIPTION

At least some aspects of the disclosure provide imaging devices and methods in digital embodiments as well as film based embodiments. Some embodiments of the devices and methods provide image capture operations or image projection operations, or both. Aspects of the disclosure describe imaging devices and imaging methods which may use chromatic dispersion according to some embodiments. According to at least some exemplary camera configurations, aspects of the disclosure provide devices and methods of increased sensitivity to received light compared with some other camera configurations. Other image capture and projection aspects are described below.

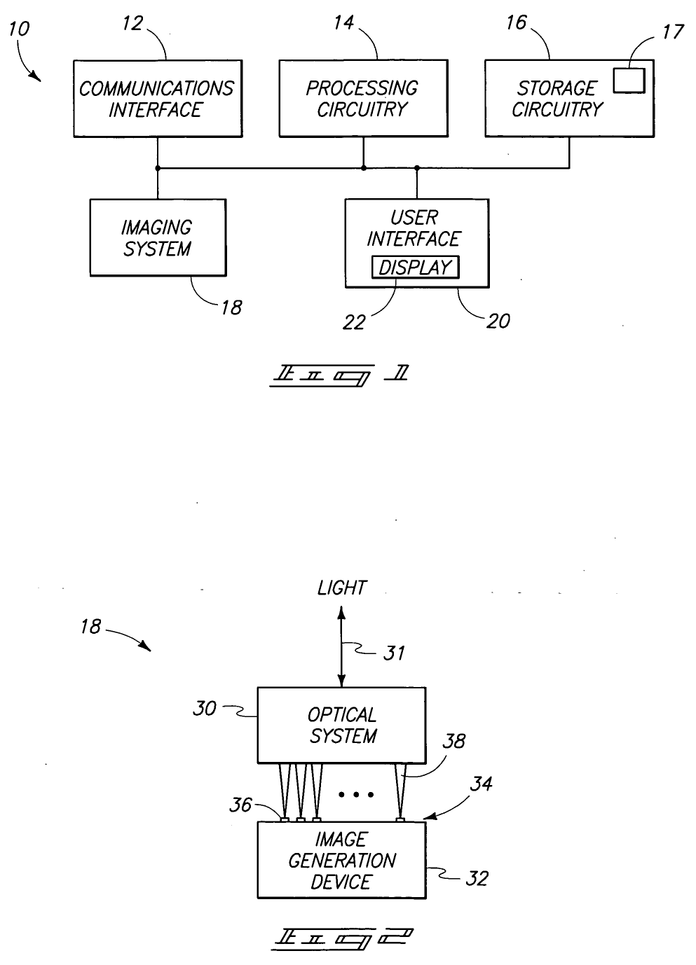

FIG. 1 shows one embodiment of an imaging device 10. Imaging device 10 may be configured to capture images of scenes in camera embodiments or output images in projector embodiments. In the depicted illustration, image device 10 includes a communications interface 12, processing circuitry 14, storage circuitry 16, an imaging system 18 and a user interface 20. Other configurations of imaging device 10 may be provided including more, less or alternative components.

Communications interface 12 is arranged to implement communications of imaging device 10 with respect to external devices not shown. Communications interface 12 may be implemented as a network interface card (NIC), serial or parallel connection, USB port, Firewire interface, flash memory interface, floppy disk drive, or any other suitable arrangement for communications. Communications interface 12 may be configured to output image data used to generate representations of captured images, to receive image data to be projected, and to communicate other data or information.

In one embodiment, processing circuitry 14 is arranged to process data, control data access and storage, issue commands, and control other desired operations of imaging device 10. Processing circuitry 14 may comprise circuitry configured to implement desired programming provided by appropriate media in at least one embodiment. For example, the processing circuitry may be implemented as one or more of a processor or other structure configured to execute executable instructions including, for example, software or firmware instructions, or hardware circuitry. Exemplary embodiments of processing circuitry include hardware logic, PGA, FPGA, ASIC, state machines, or other structures alone or in combination with a processor. These examples of processing circuitry are for illustration and other configurations are possible.

Processing circuitry 14 may be configured to process image data captured responsive to received light, generate image data to be projected by the imaging device 10 and perform other operations with respect to image capture and projection. Plural processing circuits 14 may be provided in some embodiments. For example, one processor may be implemented within a housing of a camera or a projector while another processor (e.g., in a personal computer) may be provided externally of the camera or projector. At least some of the operations of processing circuitry 14 described herein may be split between plural processors in one embodiment.

The storage circuitry 16 is configured to store electronic data and programming such as executable code or instructions (e.g., software, firmware), databases, or other digital information and may include processor-usable media. Storage circuitry 16 may be configured to store image data of captured, images and buffer image data to be projected by imaging device 10.

Processor-usable media includes any article of manufacture 17 (e.g., computer program product) which can contain, store, or maintain programming, data and digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette or zip disk, hard drive, random access memory, read only memory, flash memory, cache memory, and other configurations capable of storing programming, data, or other digital information.

At least some embodiments or aspects described herein may be implemented using programming stored within appropriate storage circuitry 16 described above or communicated via an appropriate transmission medium. For example, programming may be provided via appropriate media including for example articles of manufacture 17 described above, or embodied within a data signal (e.g., modulated carrier wave, data packets, digital representations, etc.) communicated via an appropriate transmission medium. Exemplary transmission media include a communication network (e.g., the Internet, a private network, etc.), wired electrical connection, optical connection and electromagnetic energy. Signals containing programming may be communicated for example via communications interface 12, or propagated using other appropriate communication structure or medium. Exemplary programming including processor-usable code may be communicated as a data signal embodied in a carrier wave in but one example.

Imaging system 18 may be configured to receive and capture light of images and to project images. Imaging system 18 may include a plurality of optical-electrical devices configured to associate respective electrical signals with captured light or projected light. Additional details regarding exemplary configurations of imaging system 18 are described below.

User interface 20 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface 20 may include a display 22 (e.g., cathode ray tube, LCD, etc.) configured to depict visual information as well as input keys or other input device. Any other suitable apparatus for interacting with a user may also be utilized.

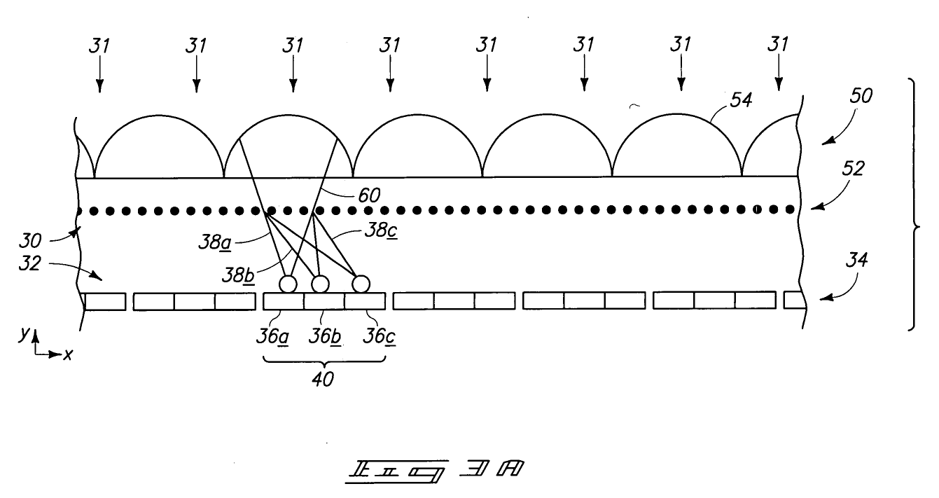

Referring to FIG. 2, a configuration of imaging system 18 is shown according to one embodiment. The illustrated imaging system 18 includes an optical system 30 optically coupled with an image generation device 32. Imaging systems 18 of FIG. 2 may be implemented in camera or projector embodiments. In camera embodiments, optical system 30 is configured to receive light 31 of images of a scene to be captured, referred to as input images or received images. In projector embodiments, optical system 30 is configured to emit light 31 of projected images.

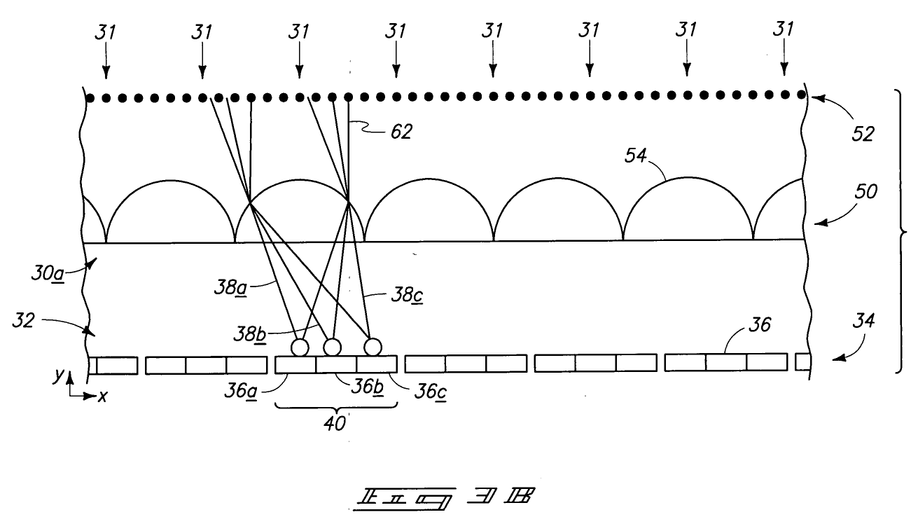

Optical system 30 is configured to implement focusing operations during image capture or image projection. For example, optical system 30 may focus light 31 (e.g., received by imaging device 10, emitted from imaging device 10) with respect to image generation device 32. As discussed further below, optical system 30 is optically coupled with image generation device 32 and may communicate a plurality of light beams 38 therebetween. Additional details of possible optical systems 30 are discussed below with respect to the exemplary embodiments of FIGS. 3A and 3B.

Image generation device 32 may be configured to generate image data of images responsive to received light in camera embodiments or emit light responsive to received image data in projector embodiments. Image generation device 32 may include an array 34 of imaging elements 36 provided in a focal plane of imaging device 10 in exemplary embodiments. Imaging elements 36 may comprise optical-electrical devices configured to generate electrical signals responsive to received light or emit light responsive to received electrical signals wherein the electrical signals may correspond to generated or received image data in respective exemplary embodiments. In other embodiments, the array 34 of imaging elements 36 may be replaced by a film.

Imaging elements 36 may be arranged in a plurality of pixel locations of array 34 comprising a two-dimensional array having a plurality of orthogonal parallel lines (i.e., rows and columns) in at least one configuration (only imaging elements 36 extending in the x direction are shown in the illustrative embodiments of FIGS. 2, 3A and 3B although imaging elements 36 are also provided in the y direction in one embodiment). Imaging elements 36 are optically coupled with respective ones of the light beams 38 which individually include different wavelengths of light (e.g., imaging elements 36a, 36b, 36c may be positioned to receive red, green and blue light, respectively, in an exemplary RGB embodiment). Although light beams 38 may individually include a single peak wavelength of light, other wavelengths of light near the peak wavelength may also be present in the light beams 38 in some embodiments. Other embodiments in addition to RGB are possible for example including less colors or more colors (e.g., in a hyperspectral camera).

Imaging elements 36 may comprise light sensing devices (e.g., CMOS or CCDs) or light emitting devices (e.g., light emitting diodes) which correspond to a plurality of pixel locations in exemplary image capture and projection embodiments, respectively. As discussed further below with respect to exemplary embodiments of the disclosure, imaging elements 36 may be configured to receive light or emit light of light beams 38 depending upon the implementation of imaging system 18 in a camera application or a projector application.

In some embodiments of imaging device 10 configured to implement both image capture and projection operations, two imaging systems 18 illustrated in FIG. 2 may be provided and individually configured to implement one of image capture or projection.

Referring to FIGS. 3A-3B, exemplary configurations of optical systems 30, 30a and image generation device 32 are shown in respective illustrative embodiments. The illustrated optical systems 30, 30a each include a lens system 50 and a dispersive element 52 optically coupled with one another. The lens system 50 may be spaced a distance from array 34 substantially equal to a focal length of lens system 50 in one embodiment. In FIGS. 3A and 3B, the positioning of lens systems 50 and dispersive elements 52 are reversed with respect to one another. The lens system 50 is configured as a lenticular array comprising a plurality of lens elements 54 embodied as semi-cylindrical lenslets in the illustrative embodiments. In some camera embodiments, a lenticular array spreads an input image into spectra including a plurality of lines and the strength of light may be sensed at various points along the spectrum for example using a broad-spectrum light sensor and a full color representation of the input image may be reconstructed as described below. Other embodiments of lens system 50 are possible including a relay lens which may provide additional room for the dispersive element 52 enabling the provision of spectra of increased size.

Referring to FIG. 3A, image capture operations of imaging system 18 are described hereafter with respect to exemplary camera embodiments. Individual ones of the lens elements 54 outputs a respective light beam 60 responsive to received light 31 (FIG. 2) which may include a plurality of different wavelengths of light of an input image. The light beams 60 are received by dispersive element 52 which separates (e.g., splits) the light of a respective light beam 60 into plural light beams 38a, 38b, 38c which are received by respective imaging elements 36a, 36b, 36c. Dispersive element 52 may be implemented as a holographic film, diffraction grating, prism, or other configuration to split received light of light beam 60 into its respective wavelength components. In the illustrated embodiment, dispersive element 52 splits each of the light beams 60 into plural light beams 38a, 38b, 38c including the respective component wavelengths of the respective light beams 60. As mentioned above, individual light beams 38a, 38b, 38c may include single peak wavelengths of light such as red, green or blue in the embodiments of FIGS. 3A and 3B. The respective light beams 38a, 38b, 38c may also include other wavelengths of light spectrally adjacent red, green or blue (i.e., light beams 38a, 38b, 38c may include different wavelengths of the spectrum). As shown, the light beams 38a, 38b, 38c correspond to a plurality of spatially separated regions of image generation device 32 corresponding respective imaging elements 36a, 36b, 36c. In one embodiment, the imaging elements 36a, 36b, 36c individually only receive substantially one peak wavelength of light corresponding to the respective wavelengths of light of the light beams 38a, 38b, 38c (e.g., red, green or blue). In other embodiments, the lens system 50 or array 34 may be moved with respect to the other such that imaging elements 36a, 36b, 36 may correspond to other wavelengths of light of the visible spectrum, for example, for use in 2D spectrophotometry providing wide color gamut images.

As mentioned above, the imaging elements 36a, 36b, 36c may be arranged in a two-dimensional array 34 and additional elements 36 (not shown) may be provided in the z-axis direction. For example, the imaging elements 36a, 36b, 36c may be arranged in a plurality of respective columns which extend in the z-axis direction of FIG. 3A in one arrangement. In addition, imaging elements 36a, 36b, 36c may be arranged in a plurality of groups 40. Groups 40 may individually include one of each of imaging elements 36a, 36b, 36c in a common row (x-axis direction) and receive light of the visible spectrum (e.g., red, green and blue light), respectively. As described further below, light received by imaging elements 36a, 36b, 36c of groups 40 may be combined to form respective regions of a representation of the input image. Regions of the representation of the input image may correspond to light combined from groups 40 of imaging elements or groups of parallel lines of imaging elements 36 and include light in the form of stripes corresponding to respective regions of the wavelengths.

In the example of FIG. 3A, respective groups 40 receive light of a plurality of respective regions of the received or input image. For example, some regions of the received image may correspond in one example to areas of light received by respective lenslets of the optical system 30 in one example. These regions may be individually defined by a distance in the x-axis dimension equal to the width (e.g., diameter) of the corresponding lens element 54 and a distance in the z-axis direction corresponding to the size of the imaging elements 36 in the z-axis direction. Other regions of the input image may be defined, for example, individually extending further in the z-axis direction (e.g., the entire length of the array 34 in the z-axis direction in one embodiment). Individual ones of the regions of the input image include a plurality of wavelengths of light corresponding to the beams 38a, 38b, 38c for the respective region.

In the described configurations of FIGS. 3A and 3B, imaging elements 36a, 36b, 36c receive substantially an entirety of the light of the respective wavelengths for the respective regions of the received image Light beams 38a, 38b, 38c include substantially an entirety of the light of the respective wavelengths received by the corresponding lens element 54 and no filtering of the light, such as Bayer-Mosaic filtering, is implemented by imaging system 18 in one embodiment. Substantially an entirety of the light of the input image received by optical system 30 is collectively received by all of the imaging elements 36 of the image generation device 32 in one embodiment. Imaging elements 36a, 36b, 36c output electrical signals corresponding to the respective wavelengths of light and which may be used by processing circuitry 14 or other circuitry to provide digital image data of a representation of the received image.

In a projector implementation of FIG. 3A, imaging elements 36a, 36b, 36c may be configured to emit light beams 38a, 38b, 38c including light of red, green and blue, respectively. Emitted light beams 38a, 38b, 38c, may form an input image in projector embodiments. For example, processing circuitry 14 may access digital image data and provide electrical signals to imaging elements 36a, 36b, 36c to generate images responsive to the image data. The dispersive element 52 combines the light of light beams 38a, 38b, 38c into light beams 60 which are magnified and projected by lens system 50 as an appropriate projected image responsive to the received light of light beams 38a, 38b, 38c.

Groups 40 of imaging elements 36 configured as light emitting devices are configured to generate light for a respective region of the output image similar to the regions of the input image described above. Optical system 30 may combine light beams 38a, 38b, 38c emitted from one of the groups 40 of imaging elements 36 to generate a respective region of the output image in one embodiment.

Referring to the exemplary embodiment of FIG. 3B with respect to a camera implementation, dispersive element 52 of optical system 30a receives light and splits the light into a plurality light beams 62 corresponding to the chromatic components of the received light 31. Len system 50 receives the light beams 62 and focuses a plurality of corresponding light beams 38a, 38b, 38c to respective imaging elements 36a, 36b, 36c which may generate image data responsive to the received light.

In a projector implementation of FIG. 3B, imaging elements 36a, 36b, 36c configured as light emitting devices emit light beams 38a, 38b, 38c responsive to control by processing circuitry 14. The light beams 38a, 38b, 38c are received by lens system 50 of optical system 30a. Lens system 50 magnifies and outputs a plurality of light beams 62 corresponding to the wavelengths of light of light beams 38a, 38b, 38c. Dispersive element 52 receives and combines the light beams 62 to project an output image corresponding to the received light.

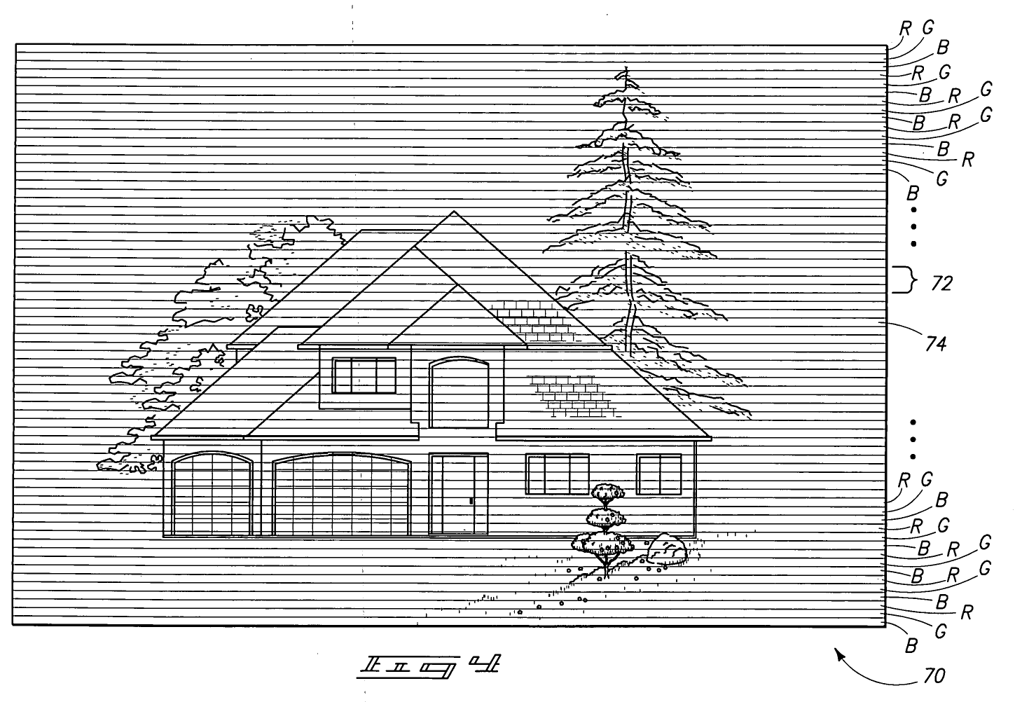

Referring to FIG. 4, an exemplary representation 70 of an input image received by imaging device 10 is shown. Representation 70 includes a plurality of groups 72 of parallel lines 74 (e.g., stripes) forming rows. The rows correspond to columns of image data provided by imaging elements 36 described with respect to FIGS. 3A-3B and groups 72 correspond to columns of groups 40 of imaging elements 36 of FIGS. 3A-3B in the described embodiment. In an exemplary RGB implementation, individual ones of the rows of the groups 72 correspond to one of three color planes (i.e., red, green or blue) in an exemplary RGB configuration. Accordingly, groups 72 may include a plurality of repetitive RGB stripes corresponding to respective lens elements 54 in one embodiment.

Processing circuitry 14 or other circuitry may process the image data corresponding to the rows of FIG. 4 to generate a more accurate representation of the input image compared with representation 70 which is provided to illustrate operational aspects of one possible implementation of imaging device 10. According to one embodiment, processing circuitry 14 may spatially and chromatically combine the image data by superimposing the image data of the respective rows of individual groups 72 over one another to generate a continuous full color image representation of the input image. More specifically, for a given group 72, the processing circuitry 14 may combine the red, green and blue image data of the respective rows of the given group to form a full color parallel line of the continuous full color image representation. Other processing embodiments are possible.

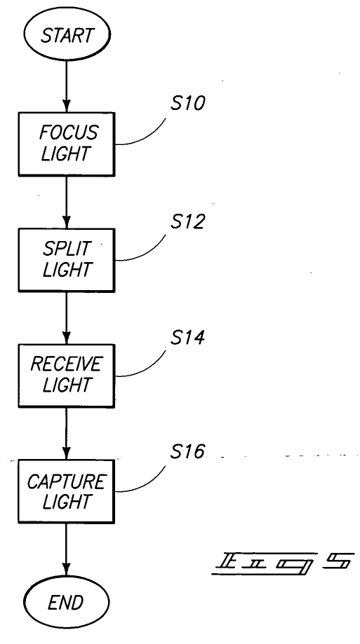

Referring to FIG. 5, an exemplary method is shown for generating images according to one embodiment. Other methods are possible including more, less or alternative steps.

At a step S10, light is received by imaging device 10 and focused by the lens system. In one embodiment, the received light corresponds to light 31 of FIG. 2.

At a step S12, received light is split into a plurality of light beams individually comprising spectral bands of light. The light beams may include different wavelengths of light in one embodiment. For example, the light beams may individually include one of red, green or blue light (and wavelengths spectrally adjacent thereto) in one embodiment.

At a step S14, the light beams are received by respective imaging elements.

At a step S16, the light beams are captured by the imaging elements. For example, in one embodiment, a plurality of electrical signals indicative of intensity of the respective light beams may be generated to capture the light beams.

At least some aspects of the disclosure are believed to be useful in relatively high resolution implementations (e.g., megapixels) where sensitivity may be more useful or important than resolution (e.g., high resolution cameras having a small fillfactor). For example, at least some of the described embodiments provide devices of increased sensitivity (i.e., approximately three times) compared with configurations which filter approximately two thirds of the light and implement demosaicing to generate full color images. Aspects of the commonly assigned co-pending U.S. patent application entitled “Imaging Apparatuses, Image Data Processing Methods, and Articles of Manufacture,” naming Amnon Silverstein as inventor, filed Oct. 31, 2003, having Ser. No. 10/698,926, and the teachings of which are incorporated by reference, may be utilized recapture or increase the spatial resolution of images.

The protection sought is not to be limited to the disclosed embodiments, which are given by way of example only, but instead is to be limited only by the scope of the appended claims.

What is claimed is:

1. An imaging method comprising:
focusing light of a plurality of wavelengths of an input image with respect to a focal plane of a camera;
splitting the light into a plurality of light beams comprising light corresponding to the respective wavelengths of light of the input image;
receiving the light beams after the focusing and the splitting; and
capturing received light of the light beams to provide a representation of the input image.

2. The method of claim 1 wherein the capturing comprises capturing substantially all of the light received by the camera.

3. The method of claim 1 wherein the receiving and capturing comprise receiving and capturing using film.

4. The method of claim 1 wherein the receiving and capturing comprise receiving and capturing using a plurality of light sensing devices.

5. The method of claim 1 wherein the light beams individually comprise one of red, green and blue light.

6. The method of claim 1 wherein the focusing comprises focusing the light beams to a plurality of regions within the focal plane, and wherein the receiving and the capturing comprise receiving and capturing using a plurality of light sensing devices arranged corresponding to the regions within the focal plane to individually receive different wavelengths of light.

7. The method of claim 1 wherein the receiving and capturing comprise receiving and capturing light received by the camera without filtering of the light.

8. The method of claim 1 further comprising providing image data responsive to the capturing to generate the representation of the input image comprising a full color representation without demosaicing.

9. An imaging method comprising:
providing light of a plurality of regions of an input image;
associating light of an individual one of the regions of the input image with a plurality of spatially separated regions, wherein the light of one of the regions of the input image comprises a plurality of wavelengths of light and wherein the spatially separated regions which correspond to the one region of the input image individually comprise light of a respective individual wavelength of the light present in the one region of the input image;
providing a plurality of electrical signals, wherein respective ones of the electrical signals correspond to respective ones of the spatially separated regions and respective ones of the different wavelengths of light; and
wherein the light of one of the spatially separated regions is substantially all of the light of the respective wavelength of the light of the one region of the input image.

10. The method of claim 9 wherein the providing the light comprises receiving the light of the input image within a camera.

11. The method of claim 9 wherein the providing the electrical signals is responsive to receiving the different wavelengths of light using a plurality of light sensing devices corresponding to respective ones of the spatially separated regions.

12. The method of claim 9 wherein the providing the light comprises emitting the light using a projector.

13. The method of claim 12 wherein the providing comprises emitting the different wavelengths of light using a plurality of light emitting devices corresponding to respective ones of the spatially separated regions.

14. The method of claim 9 wherein the spatially separated regions are arranged in a plurality of parallel lines.

15. The method of claim 9 wherein the spatially separated regions individually comprise light of only substantially the respective individual wavelength of light.

16. A camera comprising:
an optical system configured to receive a plurality of different wavelengths of light of an input image and to generate a plurality of light beams using the light of the input image and comprising respective ones of the wavelengths of light, wherein the generation of the light beams comprises separating the light of the input image into the light beams corresponding to a plurality of spatially separated regions; and
an image generation device optically coupled with the optical system and configured to receive the light beams at the spatially separated regions and to generate image data of a representation of the input image using the light of the received light beams, wherein the light beams received by the image generation device comprise substantially an entirety of the light of the respective wavelengths of light of the input image received by the camera.

17. The camera of claim 16 wherein the optical system is configured to split the light of the input image into the light beams to separate the light of the input image.

18. The camera of claim 16 wherein the optical system comprises a dispersive element configured to generate the light beams comprising the respective wavelengths of light.

19. The camera of claim 18 wherein the optical system comprises a lens system configured to focus the light beams to the spatially separated regions.

20. The camera of claim 16 wherein the optical system is configured to generate the light beams corresponding to the spatially separated regions arranged in a plurality of parallel lines.

21. The camera of claim 20 wherein the image generation device comprises a plurality of light sensing devices configured to receive the light in the spatially separated regions arranged in the parallel lines.

22. The camera of claim 21 wherein the light sensing devices of an individual one of the parallel lines receive light beams of substantially the same wavelength.

23. The camera of claim 16 wherein the image generation device is configured to provide the representation comprising a full color representation of the input image without demosaicing.

24. The camera of claim 16 wherein the optical system and image generation are configured to not filter wavelengths of light.

25. A projector comprising:
an image generation device comprising a plurality of groups of light emitting devices and wherein the light emitting devices are configured to emit light of different wavelengths to generate an output image, wherein the light emitting devices of an individual one of the groups are spatially separated from one another and are configured to emit light for a respective region of an output image corresponding to the respective individual one of the groups; and
an optical system optically coupled with the image generation device and configured to receive the light from the light emitting devices and, for an individual one of the groups, to combine light having different wavelengths from the light emitting devices of the respective individual one of the groups to generate the respective region of the output image.

26. The projector of claim 25 wherein the image generation device comprises a plurality of parallel lines of light emitting devices, and wherein the light emitting devices of a respective one of the parallel lines are configured to emit light having substantially the same peak wavelength.

27. The projector of claim 25 wherein the light emitting devices comprise light emitting diodes.

28. The projector of claim 25 wherein the light emitting devices emit substantially a single peak wavelength of light.

29. The projector of claim 25 wherein the optical system comprises a lens system configured to magnify the light emitted from the light emitting devices and a dispersive element configured to combine the light having the different wavelengths.

30. A camera comprising:
means for focusing light of a plurality of wavelengths of an input image with respect to a focal plane of a camera;
means for providing the light into a plurality of light beams comprising different wavelengths of light of the input image, and wherein the means for focusing comprises means for focusing the light beams to a plurality of different regions within the focal plane; and
means for receiving the light beams and for capturing received light of the light beams for providing a representation of the input image, wherein the light beams received by the means for receiving comprise substantially all of the light of the input image received by the camera.

31. The camera of claim 30 wherein the means for receiving and capturing comprises film.

32. The camera of claim 30 wherein the means for receiving and capturing comprises a plurality of light sensing devices.

33. An article of manufacture comprising:
media comprising programming configured to cause processing circuitry to perform processing comprising:
accessing image data generated by an image generation device of a camera responsive to received light of an input image, wherein the image data comprises image data from a plurality of light sensitive devices of the image generation device and wherein the light sensitive devices receive light of different wavelengths and the light received by an individual one of the light sensitive devices comprises substantially an entirety of the light of the respective wavelengths of one of a plurality of regions of the input image received by the camera; and
processing the accessed image data to provide image data of a representation of the input image, wherein the processing comprises, for an individual one of a plurality of regions of the representation of the input image, combining the image data of the light sensing devices which received light from a common respective region of the input image to provide image data of the respective one region of the representation of the input image corresponding to the common respective region of the input image.

34. The article of claim 33 wherein the media, the processing circuitry and the image generation device comprise components of a camera.
